(19) United States
(12) Patent Application Publication
(10) Pub. No.: US 2017/0210003 A1
(43) Pub. Date: Jul. 27, 2017

(54) Hanging System for Garden Tools and Other Implements

(71) Applicant: Daniel Kopans, Waban, MA (US)

(72) Inventor: Daniel Kopans, Waban, MA (US)

(21) Appl. No.: 15/410,970

(22) Filed: Jan. 20, 2017

Related U.S. Application Data
(60) Provisional application No. 62/286,485, filed on Jan. 25, 2016.

(51) Int. Cl. B25H 3/04; F16B 45/00; A47B 81/00

(52) U.S. Cl. CPC B25H 3/04; A47B 81/005; F16B 45/00

(57) ABSTRACT

A hanging system for garden tools and other implements is provided. The hanging system includes a hook member at a proximal end of a handle of a tool. With the hook member, the tool can be suspended from a longitudinal and horizontal support member with the tool head down, and the tool can be slid along the support member while suspended. To retrieve or replace a tool, adjacent tools can be slid along the support member so that they are less likely to become entangled and they do not interfere with removal or replacement of the tool. Because the tool head is located at the bottom, tools are less likely to fall and cause serious injury.

### CROSS REFERENCE TO RELATED APPLICATIONS

This application is a non-provisional of, and claims the benefit of, U.S. Prov. Pat. App. No. 62/286,485, filed on Jan. 26, 2016, entitled, “Hanging System for Garden Tools and Other Implements,” which is incorporated by reference herein.

### BACKGROUND

Garden tools and other implements are frequently stored in garages, sheds, and the like. A variety of storage systems are used to attempt to bring order to a jumble of tools. Storage systems often employ clips, nails, and hooks that are fastened to a wall and are often placed close together, which results in tools that overlap. If a desired tool is behind another tool, the other tool must be removed first, leading to fumbling with heavy awkward tools and possibly dropping of one or more tools. Also, clip systems often require that the tool be stored with the heavy end up. Thus, when one tool is removed, another tool is in danger of being dislodged, creating a hazard if it falls on a person. Storage racks or carts have also been provided. Such carts and racks also tend to become cluttered, and tools can only be removed with difficulty because other tools get in the way.

FIGS. 20-24 illustrate a variety of known storage systems, which suffer from one or more of these difficulties.

### SUMMARY

The invention relates to a hanging system for garden tools and other implements. A hook member is provided on a handle of a tool so that the tool can be suspended from a longitudinal and horizontal support member. The hanging system provides efficient storage of tools in a small space, while permitting removal and replacement of a tool without the need to remove other tools. Adjacent tools can be slid to the side to access a desired tool. Because tools are stored with the tool heads at the bottom, there is less chance of a tool falling and causing serious injury.

For example, one embodiment of the present invention is directed to a hanging system for tools. The hanging system includes a tool, a hook member, and a longitudinally and horizontally extending support member. The tool includes a handle extending longitudinally from a proximal end to a distal end, and a tool head at the distal end. The hook member is attached to the handle at the proximal end of the handle. The hook member includes a proximally-extending segment extending from the proximal end of the handle and a depending segment extending in a distal direction to a free end. There is a gap between the free end of the depending member and the proximal end of the handle. The hook member is configured to suspend the tool from the longitudinally and horizontally extending support member with the tool head down. The hook member is also configured to slide along the support member while suspending the tool.

Other features and advantages of various aspects and embodiments of the present invention will become apparent from the following description and from the claims.

### BRIEF DESCRIPTION OF THE DRAWINGS

FIG. 1A is a schematic illustration of a hanging system according to an embodiment of the present invention with a number of tools hanging from a support member;

FIG. 1B is a schematic illustration of the hanging system of FIG. 1A illustrating tools slid apart to retrieve a desired tool;

FIG. 2 is an illustration of a hanging system for garden tools according to another embodiment of the present invention;

FIG. 3A is a schematic illustration of a hanging system according to another embodiment of the present invention with a number of tools hanging from a support member;

FIG. 3B is a further schematic illustration of the hanging system of FIG. 3A illustrating tools slid apart to retrieve a desired tool;

FIGS. 4A-4G are schematic illustrations of hook members according to exemplary embodiments of the present invention;

FIG. 5 is a schematic illustration of a hanging system according to another embodiment of the present invention;

FIG. 6 is a schematic illustration of a swivel hook member according to another embodiment of the present invention;

FIGS. 7A-7D are schematic illustrations of a hanging system for garden tools according to another embodiment of the present invention;

FIGS. 8A-8C are schematic illustrations of a hanging system according to another embodiment of the present invention;

FIGS. 9A-9G are schematic illustrations of hanging systems according to exemplary embodiments of the present invention;

FIGS. 10A-10E are schematic illustrations of a hanging system according to another exemplary embodiment of the present invention;

FIGS. 11A and 11B are schematic illustrations of a hanging system according to another exemplary embodiment of the present invention;

FIGS. 12A-12E are schematic illustrations of a hanging system according to another exemplary embodiment of the present invention;

FIGS. 13A-13C are schematic illustrations of a hanging system according to another exemplary embodiment of the present invention;

FIGS. 14A-14C are schematic illustrations of a hanging system according to another exemplary embodiment of the present invention;

FIG. 15A is a schematic illustration of a rod-shaped support member according to another embodiment of the present invention;

FIG. 15B is a schematic illustration of exemplary cross sections of the rod-shaped support member of FIG. 15A according to additional embodiments of the present invention;

FIG. 16A is a schematic illustration of a ledge support member according to another embodiment of the present invention;

FIG. 16B is a schematic side view of the support member of FIG. 16A;

FIG. 17A is a schematic illustration of an angled board support member according to another embodiment of the present invention;

FIG. 17B is a schematic side view of the support member of FIG. 17A;

FIG. 18A is a schematic illustration of a taut wire support member according to another embodiment of the present invention;

FIG. 18B is a schematic side view of the support member of FIG. 18A;

FIG. 19A is a schematic illustration of a hanging system with a number of tools hanging from a cantilevered support member according to another embodiment of the present invention;

FIG. 19B is a schematic illustration of the hanging system of FIG. 19A illustrating tools slid apart to retrieve a desired tool;

FIG. 19C is a schematic illustration of the hanging system of FIG. 19B illustrating a desired tool removed from the hanging system;

FIG. 20 is an illustration of a prior art tool storage system;

FIG. 21 is an illustration of a further prior art tool storage system;

FIG. 22 is an illustration of a further prior art tool storage system;

FIG. 23 is an illustration of a further prior art tool storage system; and

FIG. 24 is an illustration of a further prior art tool storage system.

### DETAILED DESCRIPTION

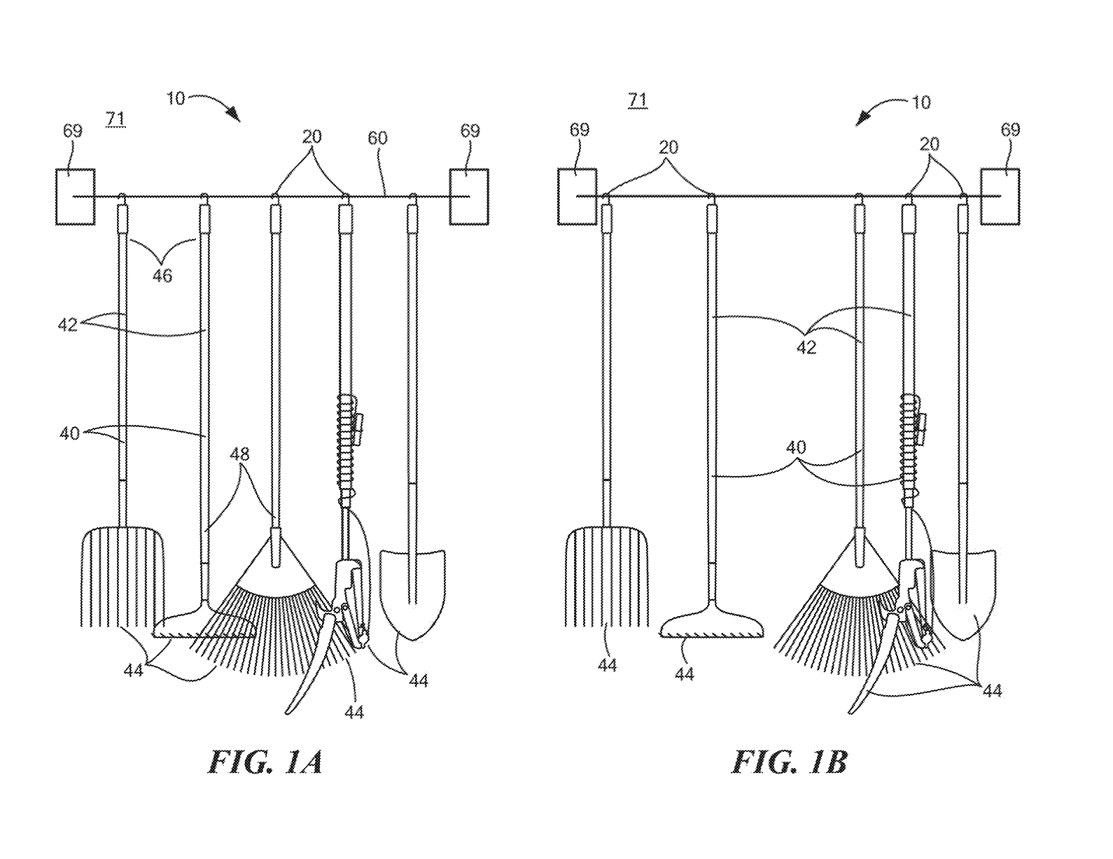

A hanging system 10 for tools, and in particular for garden tools, is provided. See FIGS. 1A and 1B. The hanging system employs a hook member 20 on an end of a handle 42 of a tool 40. The hook member is configured so that it can hook onto a longitudinal and horizontal support member 60, such as a rod, a ledge, an upwardly angled edge of a board, or a taut wire. The hook member is configured such that the tool can be suspended from the support member and moved along the support member without falling off. The hanging system can be used with a variety of garden tools and other implements, such as, without limitation, a rake, a shovel, a trowel, a fork, or a broom. The tools can be gas or electric powered tools, such as, without limitation, string trimmers, hedge trimmers, blowers, or pruning shears.

The system permits efficient storage of tools in a small space, yet permits the removal and replacement for storage of any tool, without the need to remove other tools. The other tools may be slid to the side to permit the removal and replacement of the desired tool.

The tool head or working end 44 of many garden tools is often heavy and sharp or pointed. With the present system, the working ends of the tools are disposed at the bottom, where there is less chance for a falling tool to cause a serious injury should one or more tools fall, as can be the case when tools are hung with their heavy working ends up. Also, there is less opportunity for tools to become entangled, which can be a particular problem for tools having sharp or pointed features, such as tines on a rake or fork.

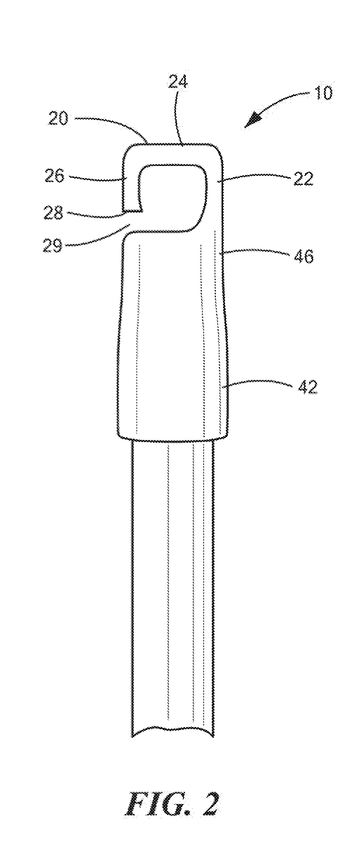

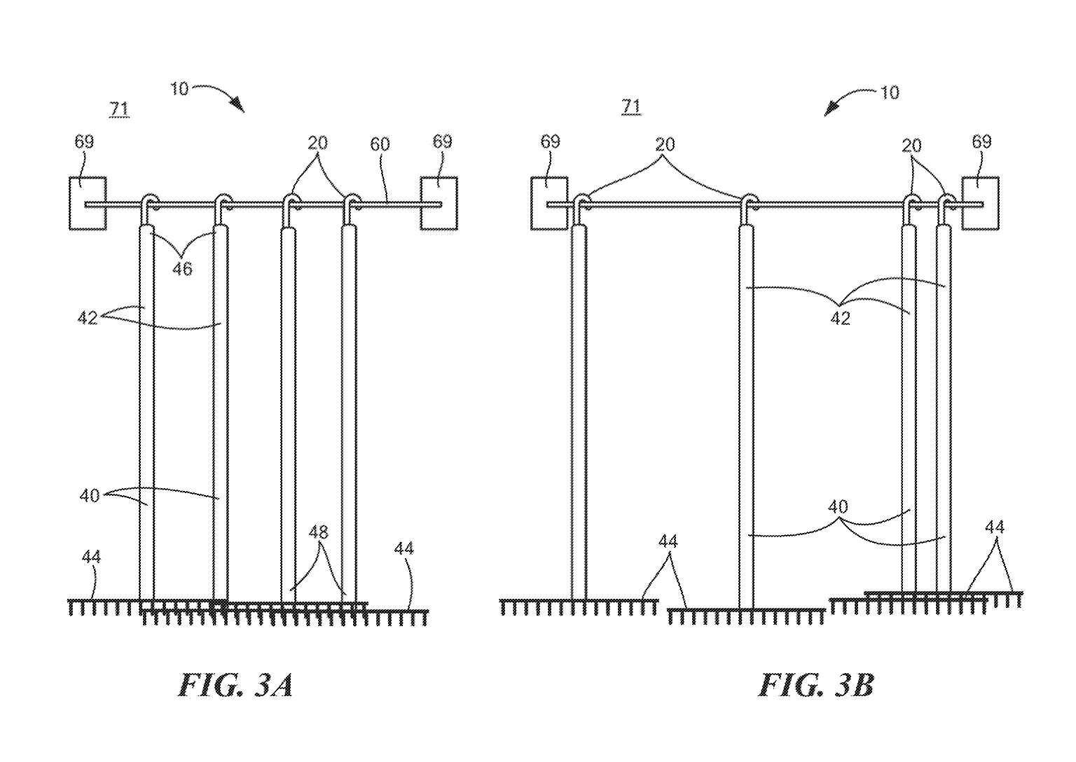

FIG. 2 illustrates one embodiment of a hook member 20 of a hanging system 10 for a garden tool. The hook member is attached to a handle 42 of a tool at the proximal end 46 of the handle. The tool handle typically extends longitudinally from the proximal end to a distal end 48, with a tool head 44 attached at the distal end. (See FIG. 1A.) The handle may, for example, have a generally circular, rounded, or other cross section. The hook member is configured to suspend the tool from a longitudinally and horizontally extending support member 60 with the tool head 44 down. The hook member is further configured to slide along the support member while suspending the tool. See also FIGS. 3A-3B.

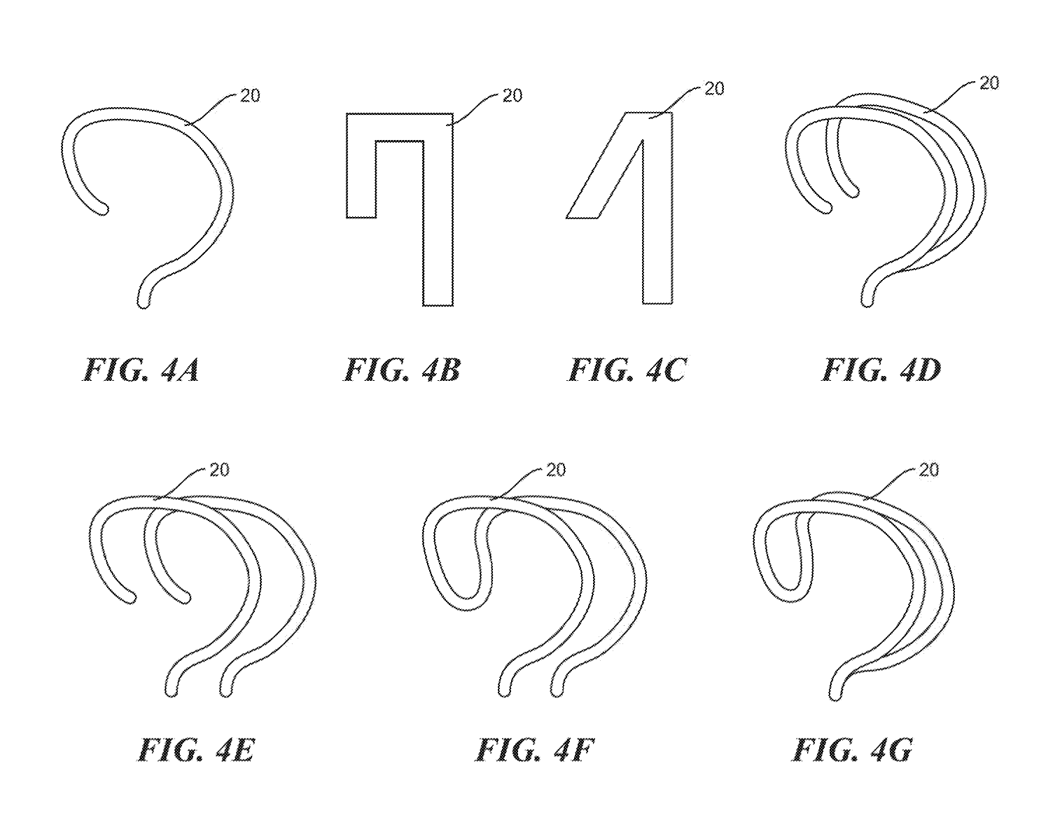

As illustrated in FIGS. 4A-4G, hook members can be shaped in any suitable configuration to suspend the tool from a longitudinally and horizontally extending support member. For example, hook members may be round or circular (FIG. 4A), angular (FIG. 2), square (FIG. 4B), geometric (FIG. 4C), irregular, bent, or even include multiple extending segments (open or closed) (FIGS. 4D-4G.).

In the embodiment of FIG. 2, the hook member 20 has a generally angular shape. The hook member has a proximally-extending segment 22 extending from the proximal end 46 of the handle 42. A cross segment 24 is integral with the proximally-extending segment and extends transversely over the cross section of the handle. A depending segment 26 is integral with the cross segment and extends in a distal direction to a free end 28. A gap 29 is provided between the free end of the depending member and the proximal end of the handle. The proximally extending segment 46 of the hook member has an outer edge generally aligned with an outer edge of the handle. The gap 29 of the hook member is aligned with an outer edge of the handle.

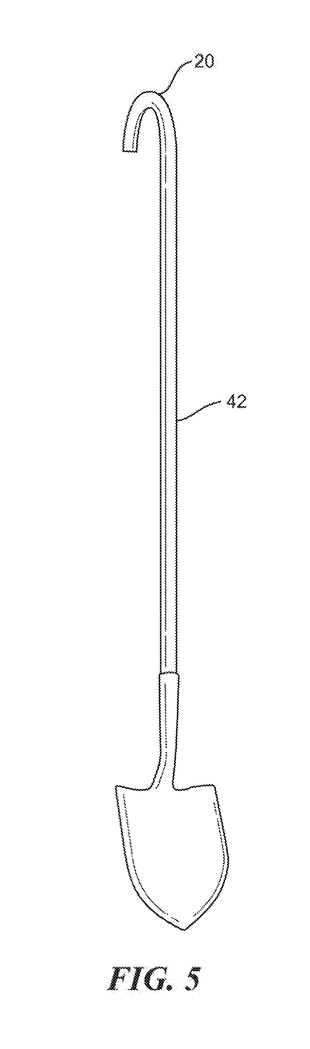

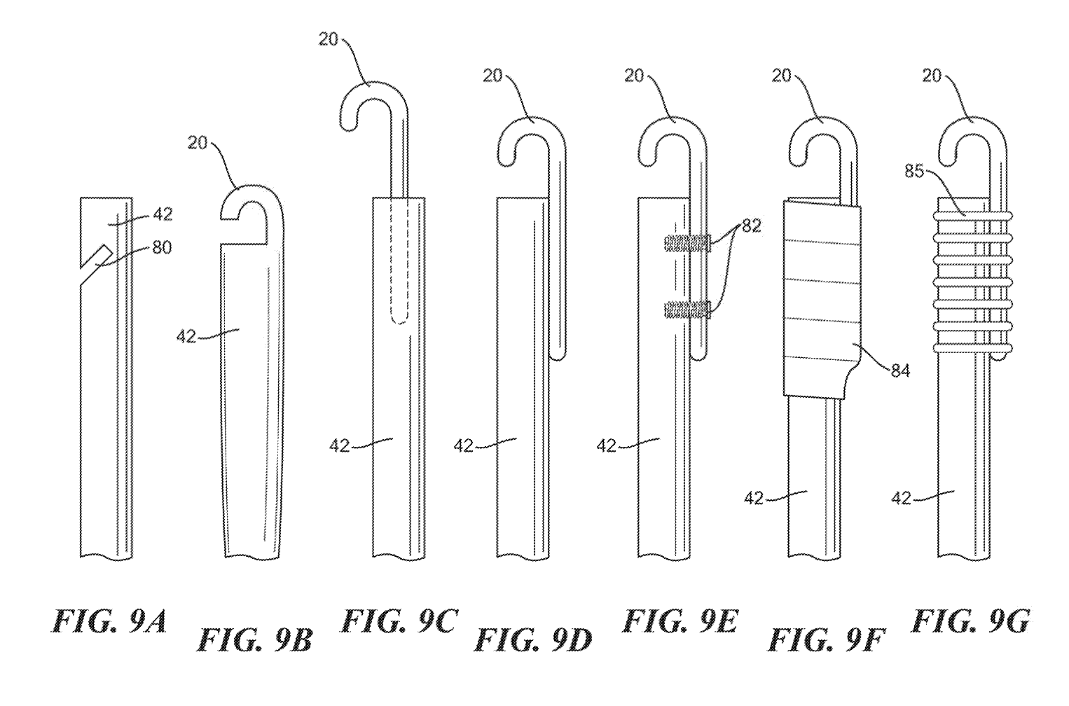

In some embodiments, a hook member 20 can be integrally formed into an end of the handle 42. For example, FIGS. 5 and 9B illustrate hook members 20 that can be molded into the handle at the time of manufacture. In another embodiment, a hook can be machined into the end of the handle.

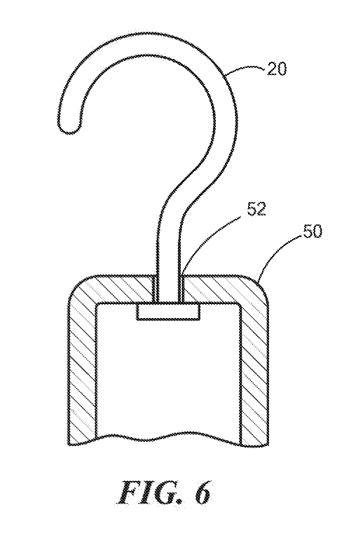

In some embodiments, the hook member 20 can be attached to the proximal end of the handle 40 of the tool with a swivel mount. For example, in the embodiments of FIG. 6, a swivel mount 56 allows the hook member 20 to rotate about a longitudinal axis defined generally by the handle 42 of the tool. Any degree of rotation can be provided, including unlimited 360° rotation. In this manner, a tool can be rotated so that it does not interfere with an adjacent tool hanging from the same support member.

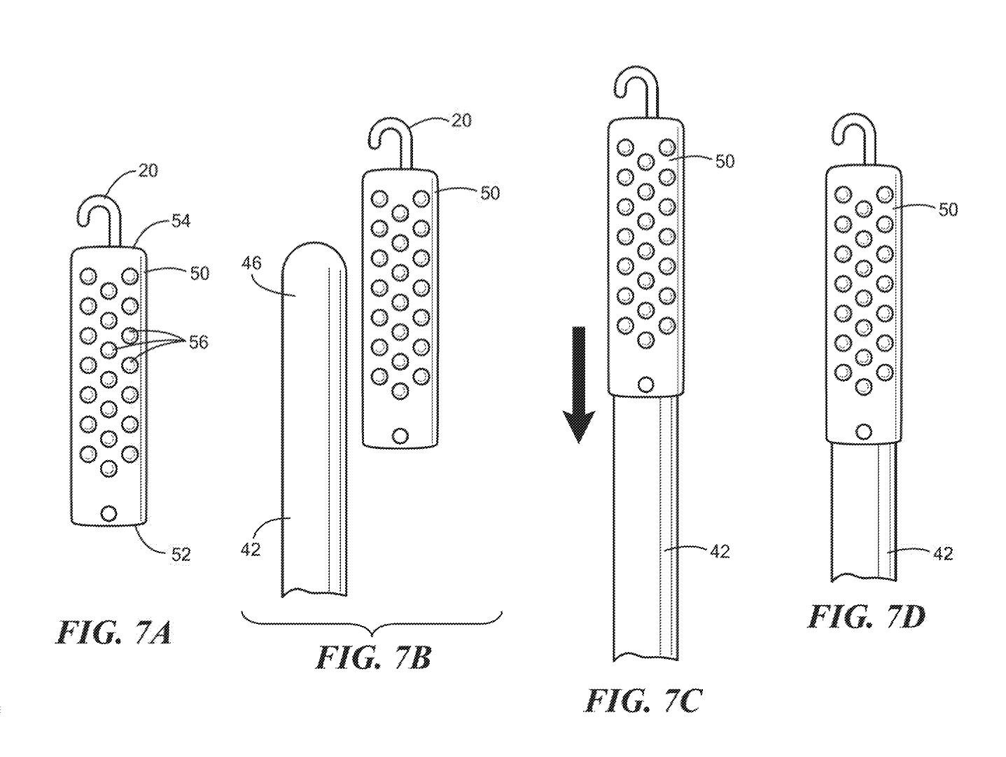

FIGS. 7A-7D illustrate a further embodiment of a hook member 20. In this embodiment, the hook member has a rounded or circular shape formed by the proximally-extending segment, cross segment, and depending segment. The proximally-extending segment of the hook member extends from a midsection of the cross section of the handle.

Referring again to FIGS. 7A-7D, in some embodiments, the hanging system can include a sleeve member 50. The sleeve member can be formed of a tubular element having an open distal end 52 and a closed proximal end 54. The hook member 20 is attached to the closed proximal end of the sleeve member. An inner diameter of the tubular element is substantially equal to an outer diameter of the handle, such that the sleeve member can be disposed over the proximal end of the handle with a close fit. See FIGS. 7C and 7D. The sleeve member can include interior gripping elements, such as nubs and/or longitudinal or circumferential ribs, to assist the sleeve in gripping the tool handle. The sleeve member can include tactile gripping elements 56 formed on an outer surface. For example, tactile gripping elements can include a plurality of nubs formed on the surface. The tactile gripping elements can aid a user is placing the sleeve on a tool handle, and in retrieving a tool that has been suspended using the hanging system described herein.

As shown in FIGS. 7A-7D, the sleeve member 50 can be slipped over the proximal end 46 of the tool handle 42. In this way, tools with an appropriate handle configuration can be retrofitted with the hanging system. The sleeve member can be attached to the proximal end of the handle in any suitable manner. For example, in some embodiments, the sleeve member can be attached with a friction fit, such as a friction fit between inside of the sleeve against the outer surface of the handle 42. Additionally or alternatively, the elasticity of the sleeve 50 may attach the sleeve to the handle 42. In other embodiments, the sleeve member 50 can be attached to the handle 42 with a mechanical fastener, such as a screw, a staple, a wire, a pin, and the like. For example, one or more screws or other fasteners may extend through the sleeve 50 and into the handle 42. In other embodiments, the sleeve member can be attached to the handle with an adhesive, such as glue, tape, and the like. In other embodiments, the sleeve member 50 can be attached to the handle 42 with a hook and loop fastener. In other embodiments, the sleeve member 50 may be attached to the handle 42 with a binding using, e.g., thread, line and/or wire. In some embodiments, the sleeve member can have a cross-sectional configuration that conforms to a cross-sectional configuration of the handle.

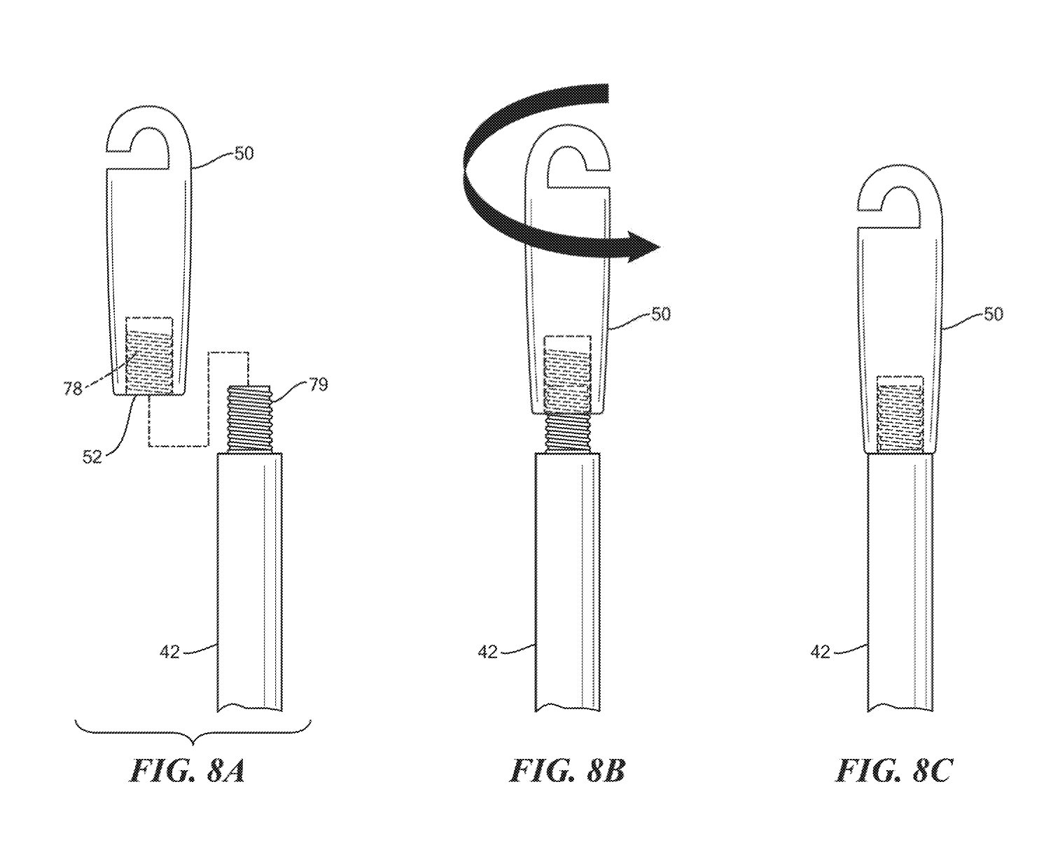

As shown in FIGS. 8a-8c, the open distal end 52 of the sleeve member 50 can include threads 78. The proximal end of the handle 42 can include threads 79 corresponding to the threads 78 of the sleeve member 50. The sleeve member 50 with threads 78 may be threaded onto the handle 42 with threads 79. Stated differently, the threads in the sleeve member may be threaded onto the threads 79 of a threaded handle. In other embodiments, the handle 42 can include an open end within which threads are provided to receive threads from an outer surface of the sleeve member or hook member.

In some embodiments, the hook member 20 can be formed integrally with the sleeve member 50 from a single material. In other embodiments, the hook member and the sleeve member can be formed from different materials.

In some embodiments, the hook member 20 can be attached to the sleeve member 50 with a swivel mount 52. See FIG. 5. The swivel mount allows the hook member to rotate about a longitudinal axis defined generally by the handle of the tool. Any degree of rotation can be provided, including unlimited 360° rotation. In this manner, a tool can be rotated so that it does not interfere with an adjacent tool hanging from the same support member.

In some embodiments, the hook member 20 can be attached to or part of the handle 42 of the tool 40. For example, in FIG. 9A, a slot 80 is provided in the handle 42 of the tool. The slot 80 forms the hook member and is located at the proximal end of the handle. The slot 80 includes a proximally-extending segment extending from the proximal end of the handle and a depending segment extending in a distal direction to a free end, resulting in a gap between the free end of the depending member and the proximal end of the handle.

In FIG. 9B, hook member 20 is molded into the handle at the time of manufacture. In other embodiments, the hook member 20 can be attached to the handle with an adhesive, such as glue. For example, in the embodiment shown in FIG. 9C, the hook member is glued within a hollow area within the end of the handle 42. In another embodiment shown in FIG. 9D, the hook member 20 can be attached by an adhesive to an outer surface of the handle 42. In other embodiments, the hook member 20 can be attached to the handle 42 using a mechanical fastener, such as a screw, a staple, a wire, a pin, and the like. For example, in the embodiment shown in FIG. 9F, the hook member 20 can be attached to the handle 42 using screws 82. In other embodiments, the hook member 20 can be attached to the handle 42 with an adhesive, such as tape 84, such as shown in FIG. 9G. In other embodiments, the hook member 20 can be attached to the handle with a hook and loop fastener. In other embodiments, the hook member 20 can be attached to the handle 42 by a binding fastener 85, such as line, wire, wrap or the like.

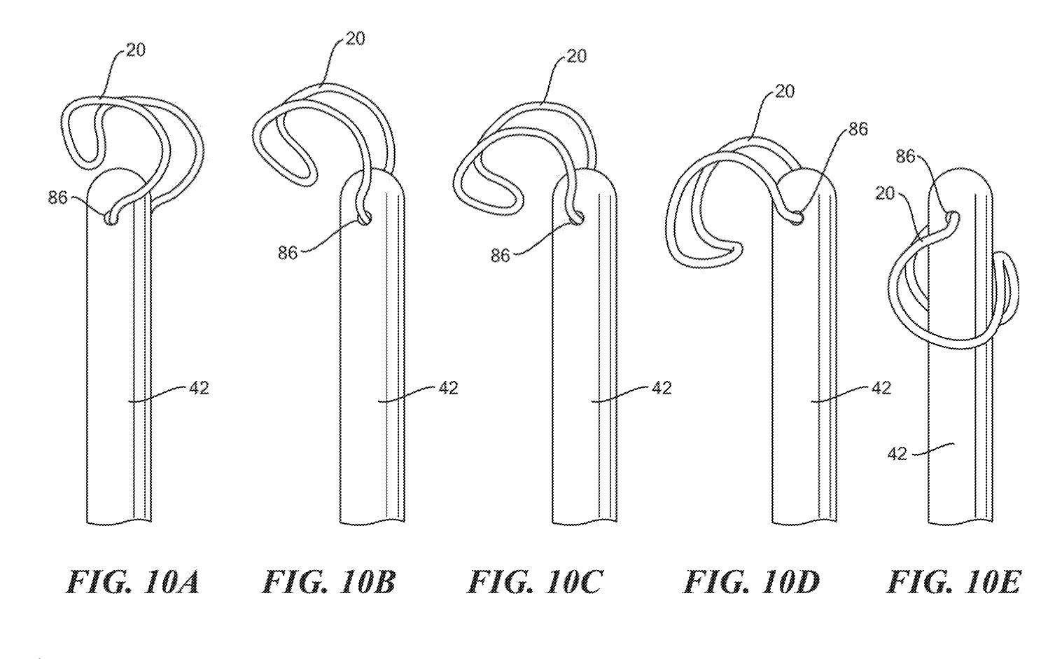

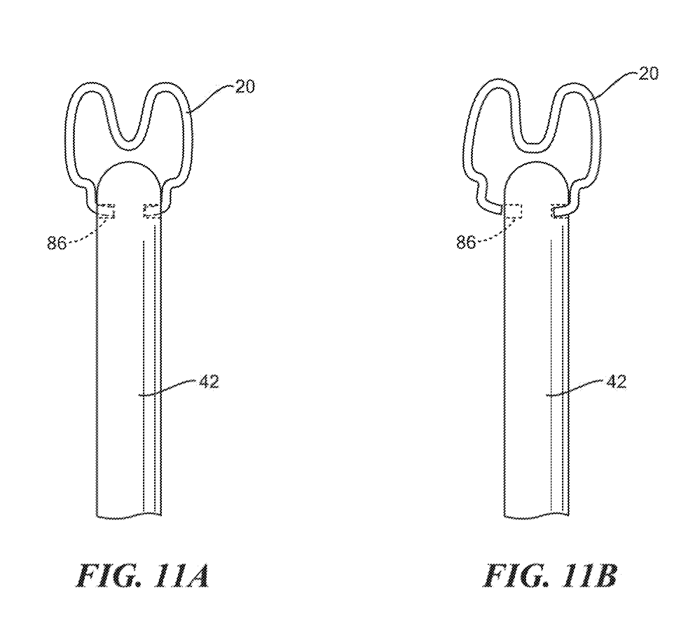

In some embodiments, the hook member 20 can be attached to the tool 40 by one or more holes or depressions in the handle 42 of the tool. For example, in FIGS. 10A-10E, a hole 86 extends through handle 42 of the tool 40. The hook member 20 can extend through the hole 86 and rotate about an axis defined by the hole 86. The hook member 20 may rotate from a hanging position as shown in FIGS. 10A and 10B to a downward or stowed position as shown in FIGS. 10D and 10E. In the stowed position shown in FIGS. 10D and 10E, the hook member 20 is folded downward against or near the handle 42 of the tool. It may be desirable for the hook member 20 to be placed in the stowed position while the tool is being used so as to reduce chances of injury or other undesired contact with the hook member 20. In another embodiment shown in FIGS. 11A and 11B, a hole 86 can extend through handle 42 of the tool 40. Ends 88 of the hook member 20 are inserted partially into the handle of the tool 40. Ends 88 of the hook member 20 may rotate about an axis defined by the hole 86. The hook member 20 may rotate from a hanging position as shown in FIG. 11B to a stowed position (not shown) while the tool is being used.

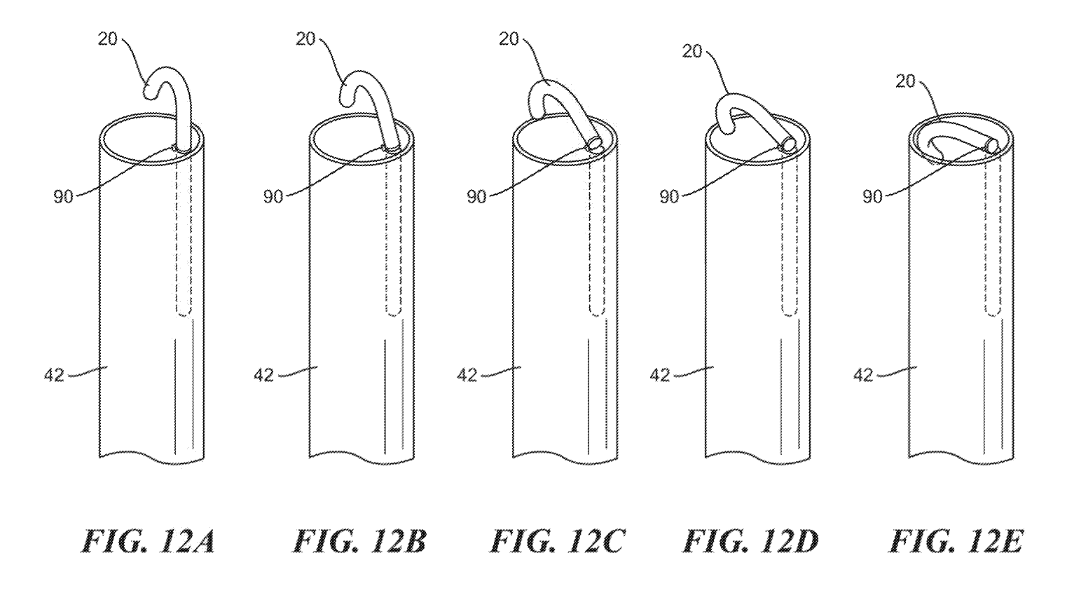

In some embodiments, the hook member 20 may include a movable joint or mechanism so that the hook member 20 may be rotated from a hanging position to a sideways or stowed position. For example, in the embodiment shown in FIG. 12A-12E, the hook member 20 can include a hinge 90. The hook member 20 can be rotated from a hanging position as shown in FIG. 12A to a stowed position as shown in FIG. 12E. In the stowed position shown in FIG. 12E, the hook member 20 can be folded to be flush against the top of the handle 42 of the tool 40.

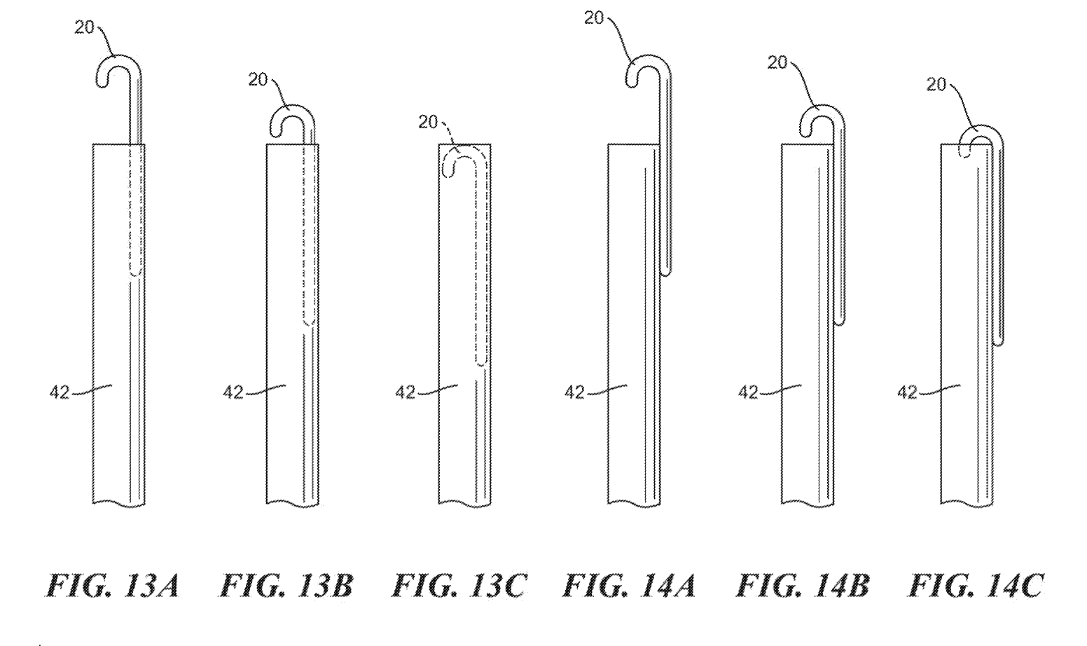

In other embodiments, the hook member 20 can be provided with a sliding mechanism so that the hook member 20 can be slid from a hanging position to a stowed position. For example, in the embodiment shown in FIGS. 13A-13C, the hook member 20 is mounted to a slidable track within the handle 42 of the tool 40. The hook member 20 may slide from an upward or hanging position as shown in FIG. 13A to a lowered or stowed position as shown in FIG. 13C. In the stowed position, the hook member 20 is inserted within the handle 42 of the tool. In the embodiment shown in FIGS. 14A to 14C, the hook member 20 is mounted to a slidable track on the outside of the handle 42 of the tool 42. The hook member 20 may slide from an upward or hanging position as shown in FIG. 14A to a lowered or stowed position as shown in FIG. 14C. In the stowed position, a portion of the hook member 20 is inserted within the handle 42 of the tool.

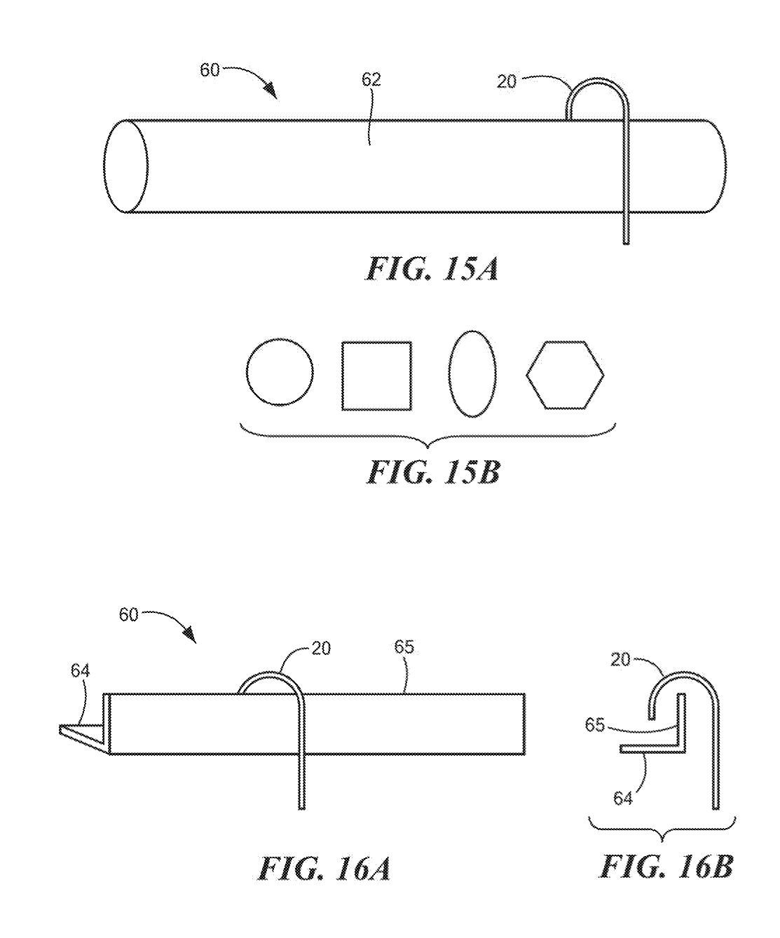

FIGS. 15A-15B schematically illustrate several embodiments of a longitudinal and horizontal support member 60 for use in the hanging system. The support member has a dimension in a transverse direction that is sized to fit through the gap 29 between the hook member 20 and the proximal end of the handle. The support member has a cross section configured to fit within an opening defined by the hook member sufficient to suspend the hook member and the tool from the support member.

FIG. 15A schematically illustrates a rod 62 that can be mounted at one or both ends in a horizontal orientation. The hook member 20 can fit over the rod and can slide along the rod. The rod can be solid or hollow and can have any suitable cross section, such as, without limitation, circular, rectangular, oval, or hexagonal, as shown in FIG. 15B.

FIGS. 16A and 16B schematically illustrate a ledge 64 that includes an upstanding lip or edge 65 over which a hook member 20 can be suspended.

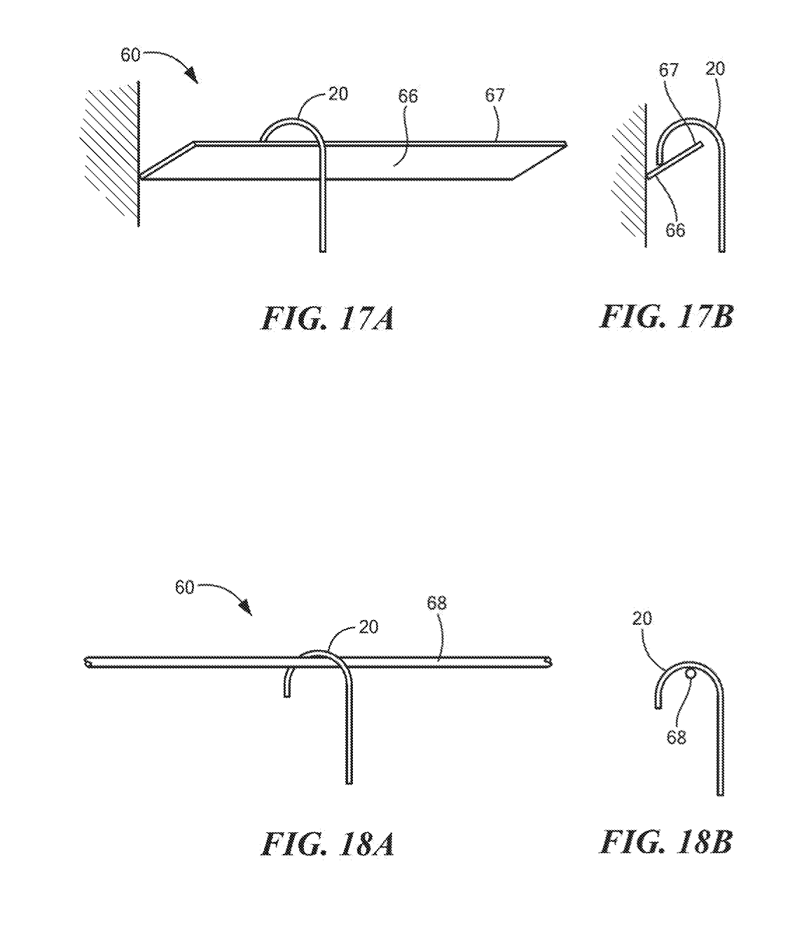

FIGS. 17A and 17B schematically illustrate a board member 66 that can be mounted at an upwardly inclined angle to provide a narrow edge 67 over which a hook member can be suspended.

FIGS. 18A and 18B schematically illustrate a taut wire 68 that can be mounted at opposite ends under tension. The wire can be selected to be sufficiently strong and can be mounted to be able to support tools without undue sagging. The hook member can be suspended from the wire.

The horizontal support member 60 can be mounted away from a wall a sufficient distance so that the hooks and the tool do not impact the wall. In some embodiments, the horizontal support comprising a rod, ledge, or board embodiment can be cantilevered from the wall. In some embodiments, the horizontal support can be mounted on a free standing support, which can be mobile to be moved to any convenient location. In some embodiments, the horizontal support can be mounted within a shed.

A support member 60 can be mounted at opposite ends to mounting brackets 69 attached to a wall 71, as indicated schematically in FIGS. 1A-1B. In operation, a number of garden tools 40 can be suspended from the support member by the hook member 20, as described above. When it is desired to select a tool to use, the adjacent tools can be slid away so that the desired tool can be easily selected and lifted off the support member, as indicated in FIG. 1B. For purposes of illustration, the tools are all schematically shown as rakes. However, it will be appreciated that the tools can be different.

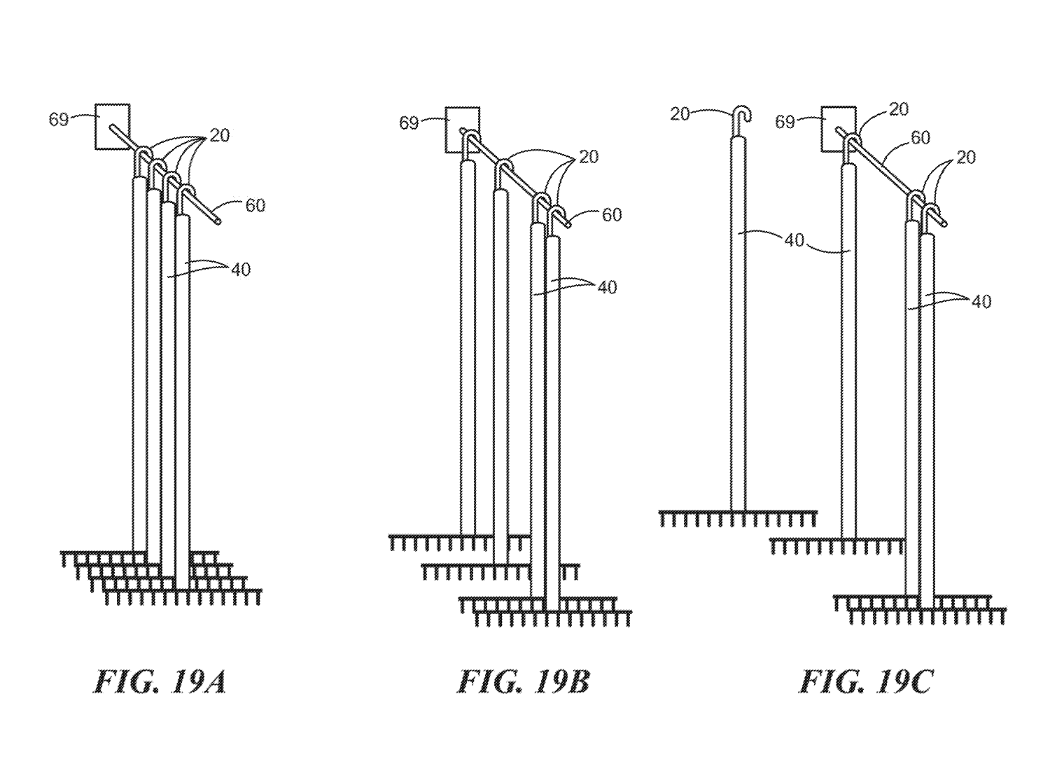

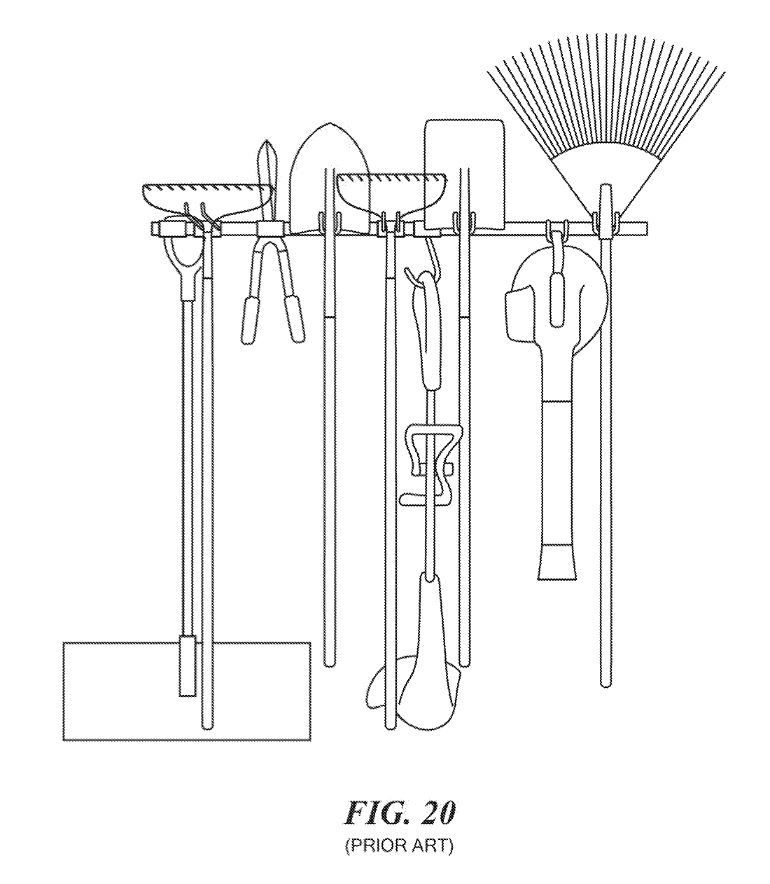

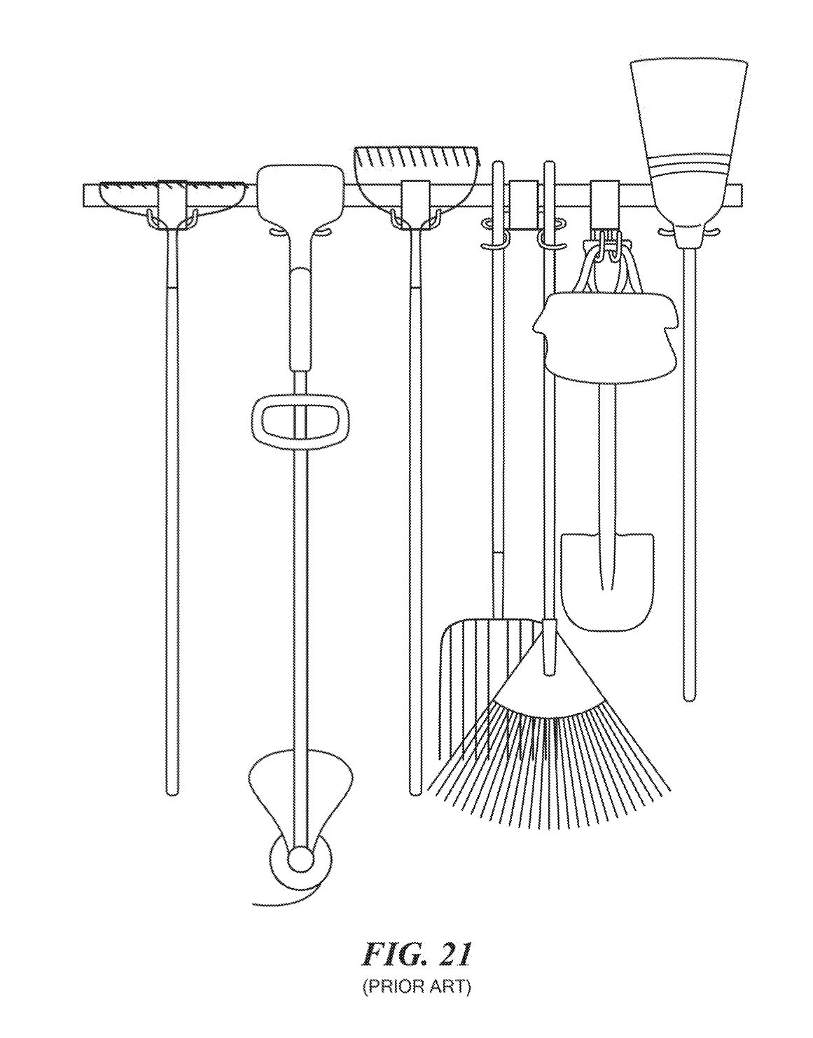

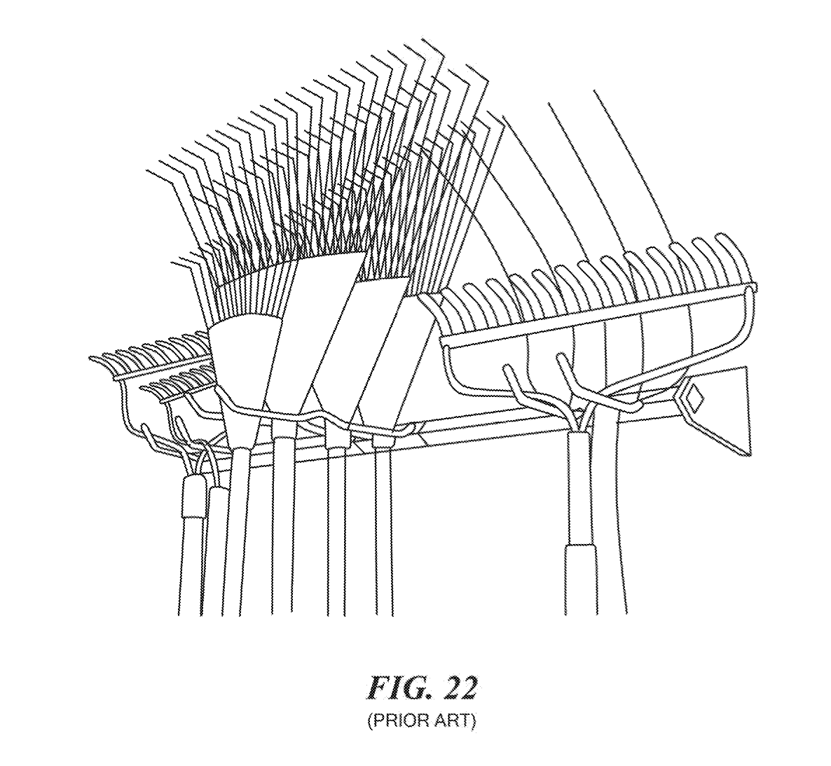

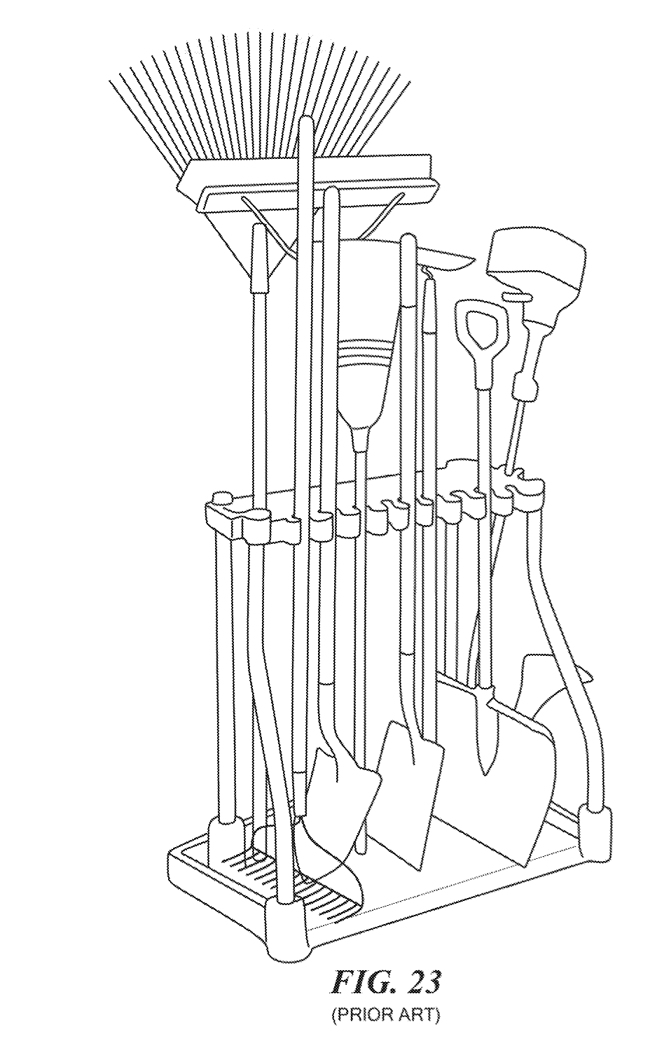

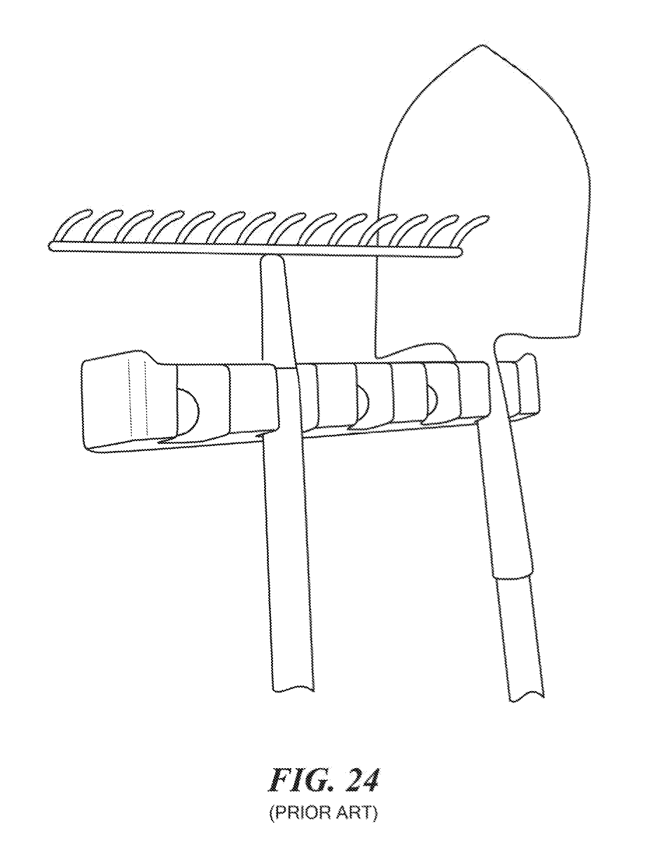

In a further embodiment, a support member 60 can be mounted at one end from a mounting bracket 69 so that the support member is cantilevered from a wall, as indicated schematically in FIGS. 19A-19C. In operation, a number of garden tools can be suspended from the support member with the hook member, as described above. When it is desired to select a tool to use, the adjacent tools can be slid away so that the desired tool can be easily selected and lifted off the support member, as indicated in FIGS. 19B and 19C. For purposes of illustration, the tools are all schematically shown as rakes. However, it will be appreciated that the tools can be different.

The system is particularly useful for tools having tool heads with tines or other pointed or irregular configurations, such as rakes and forks, that can become entangled with other tools. The rake or fork or other entangling tool can be slid aside so that it does not become entangled with the adjacent tools.

The hook member 20 and sleeve member 50 can be manufactured in any suitable manner. In some embodiments, the hook member and sleeve member can be manufactured as a single part by injection molding. In other embodiments, the hook member and the sleeve member can be formed separately and subsequently joined together, either of a same material or of different materials. Multi-material molding processes, such as overmolding and insert molding, can be used.

Any suitable polymeric material can be used. Examples include, without limitation, thermoplastic polymers such as nylon, polyethylene, polypropylene, polystyrene, and polyvinyl chloride; thermosetting polymers such as epoxy resin, polyester, polyurethane, and phenolic resin; and photopolymers.

In some embodiments the hook member can be fabricated of a metal material, such as aluminum or alloys thereof, for assembly with a sleeve member formed of a polymeric material.

In some embodiments, the hook member and the tool handle can be formed integrally from a wood material, a thermosetting polymer, a thermoplastic polymer, or a photopolymer.

The hook member and/or sleeve member can be made using various additive manufacturing processes, such as stereolithography, fused deposition, selective sintering with heat or laser, and the like, in which a product is fabricated layer by layer. For example, a three-dimensional design of the product can be generated, for example, using any suitable computer aided design system or from a scan of the product. The three-dimensional data can be converted into a stereolithographic or STL file or other suitable file format that can be further processed to produce a data file of two-dimensional slices suitable for use by an additive manufacturing device to generate a three-dimensional object layer by layer.

Although certain embodiments of the present invention apply to garden tools, this is not a limitation of the present invention. Rather, any of the features disclosed herein may be applied to any kind of object, not merely to garden tools. Examples of such kinds of objects include, without limitation, shop tools and kitchen implements (e.g., pots, pans, strainers, utensils, ladles, and spatulas).

As used herein, “consisting essentially of” allows the inclusion of materials or steps that do not materially affect the basic and novel characteristics of the claims. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. A hanging system for tools comprising:
a tool comprising:
a handle extending longitudinally from a proximal end to a distal end, and
a tool head at the distal end;
a hook member attached to the handle at the proximal end of the handle, the hook member comprising:
a proximally-extending segment extending from the proximal end of the handle,
and
a depending segment extending in a distal direction to a free end, a gap between the free end of the depending member and the proximal end of the handle; and
a longitudinally and horizontally extending support member,
wherein the hook member is configured to suspend the tool from the longitudinally and horizontally extending support member with the tool head down, the hook member further configured to slide along the support member while suspending the tool.

2. The hanging system of claim 1, wherein the hook member further comprises a cross segment integral with the proximally-extending segment and extending transversely over the cross section of the handle, wherein the depending segment is integral with the cross segment.

3. The hanging system of claim 2, further comprising a sleeve member, the sleeve member comprising a tubular element comprising an open distal end and a closed proximal end, an inner diameter of the tubular element substantially equal to an outer diameter of the handle, the sleeve member disposed over the proximal end of the handle, the hook member attached to the closed distal end of the sleeve member.

4. The hanging system of claim 3, wherein the hook member is attached to the sleeve member with a swivel mount.

5. The hanging system of claim 3, wherein the hook member and the sleeve member are integrally formed of a same material.

6. The hanging system of claim 3, wherein the hook member and the sleeve member are formed of different materials.

7. The hanging system of claim 3, wherein the sleeve member includes one or more tactile gripping elements formed on an outer surface of the tubular element.

8. The hanging system of claim 3, wherein the sleeve member includes one or more internal gripping elements formed on an inner surface of the tubular element.

9. The hanging system of claim 3, wherein an inner surface of the tubular element of the sleeve member includes first threads, wherein an outer surface of the proximal end of the handle of the tool includes second threads.

10. The hanging system of claim 1, wherein the longitudinally and horizontally extending support member is configured for mounting in a horizontal orientation, the longitudinally and horizontally extending support member comprising a dimension in a transverse direction sized to fit through the gap between the hook member and the proximal end of the handle and comprising a cross section configured to fit within an opening defined by the hook member sufficient to suspend the hook member and the tool from the support member.

11. The hanging system of claim 10, wherein the longitudinally and horizontally extending support member comprises a rod, a ledge having a vertically upstanding edge or lip, a board member comprising a narrow edge configured for mounting at an upstanding angle, or a taut wire.

12. The hanging system of claim 10, wherein the tool comprises a garden tool including a tool head with tines, and further comprising a second garden tool including a second attached hook member, the garden tool and the second garden tool hangable from the longitudinal and horizontally extending support member.

13. The hanging system of claim 1, wherein the tool comprises a garden tool.

14. The hanging system of claim 13, wherein the garden tool comprises a rake, a shovel, a trowel, a fork, a broom, a string trimmer, a hedge trimmer, a blower, or pruning shears.

15. The hanging system of claim 13, wherein the garden tool comprises a gas or electric powered tool.

16. The hanging system of claim 1, wherein the hook member and the handle are integrally formed from a same material.

17. The hanging system of claim 2, wherein the proximally extending segment of the hook member has an outer edge generally aligned with an outer edge of the handle.

18. The hanging system of claim 1, wherein the proximally-extending segment of the hook member extends from a midsection of the cross section of the handle.

19. The hanging system of claim 1, wherein the gap of the hook member is aligned with an outer edge of the handle.

20. The hanging system of claim 2, wherein the hook member is attached to the handle with a swivel mount.

21. The hanging system of claim 2, wherein the hook member is attached to the handle with one or more of the group consisting of a mechanical fastener, an adhesive fastener, or an binding fastener.

22. The hanging system of claim 2, wherein the hook member is attached to the handle with one or more holes or depressions in the handle of the tool.

23. The hanging system of claim 22, wherein the hook member is rotatable about an axis defined by the one or more holes or depressions from a hanging position to a stowed position.

24. The hanging system of claim 2, wherein the hook member is attached to the handle with a movable joint, wherein at least a portion of the hook member is rotatable about an axis defined by the movable joint from a hanging position to a stowed position.

25. The hanging system of claim 2, wherein the hook member is slidably attached to the handle of the tool, wherein the hook member is slidable from a hanging position to a stowed position.

26. The hanging system of claim 1, wherein the handle has a generally circular or rounded cross section.
